(19) United States
(12) Patent Application Publication
(10) Pub. No.: US 2013/0101495 A1
(43) Pub. Date: Apr. 25, 2013

(54) SYSTEMS AND METHODS FOR CONTINUOUSLY PRODUCING CARBON NANOSTRUCTURES ON REUSABLE SUBSTRATES

(71) Applicant: APPLIED NANOSTRUCTURED SOLUTIONS, LLC, Baltimore, MD (US)

(72) Inventors: Bradley W. PETERSON, Silver Spring, MD (US); Melissa L. JONES, Baltimore, MD (US); Tushar K. SHAH, Fulton, MD (US); Mark R. ALBERDING, Glen Arm, MD (US)

(73) Assignee: APPLIED NANOSTRUCTURED SOLUTIONS, LLC, Baltimore, MD (US)

(21) Appl. No.: 13/655,348

(22) Filed: Oct. 18, 2012

Related U.S. Application Data
(60) Provisional application No. 61/549,182, filed on Oct. 19, 2011.
(60) Provisional application No. 61/707,738, filed on Sep. 28, 2012.

(51) Int. Cl. B32B 37/14; D01F 9/12; B82Y 40/00; B82Y 30/00

(52) U.S. Cl. 423/447.2; 156/501; 156/246; 977/843; 977/742

(57) ABSTRACT

A system includes a reusable substrate upon which a carbon nanostructure is formed as a carbon nanostructure-laden reusable substrate, a first conveyor system adapted to continuously convey the reusuable substrate through a carbon nanotube catalyst application station and carbon nanostructure growth station, and a second conveyor system adapted to create an interface between a second substrate and the carbon nanostructure-laden reusuable substrate, the interface facilitating transfer of a carbon nanostructure from the carbon nanostructure-laden reusuable substrate to the second substrate. A method includes growing a carbon nanostructure on a reusable substrate, the carbon nanostructure includes a carbon nanotube polymer having a structural morphology comprising interdigitation, branching, crosslinking, and shared walls and transferring the carbon nanostructure to a second substrate to provide a carbon nanostructure-laden second substrate. The method is adapted for continuous carbon nanostructure production on the reusable substrate. A pre-preg includes such a carbon nanostructure.

### CROSS-REFERENCE TO RELATED APPLICATION

The present application claims the benefit of U.S. Provisional Patent Application Ser. No. 61/549,182, entitled “METHOD FOR CONTINUOUSLY PRODUCING CARBON NANOSTRUCTURES IMPREGNATED MATERIALS ON REUSABLE SUBSTRATES” filed Oct. 19, 2011, and U.S. Provisional Patent Application Ser. No. 61/707,738, entitled “NANOSTRUCTURE AND METHOD OF MAKING THE SAME” filed Sep. 28, 2012 which are hereby incorporated by reference in their entirety for all purposes.

### FIELD OF THE INVENTION

The present invention relates to composite materials, and more particularly, composite materials that incorporate carbon nanostructures.

### BACKGROUND OF THE INVENTION

Incorporating carbon nanotubes (CNTs) into composite materials can be accomplished by various techniques including physically mixing the nanotubes in a composite matrix material or via direct growth on a substrate. CNT loading in physical mixing processes can be limited due to the large increases in viscosity as the CNT concentration is increased. Other limitations arise due to the limited ability to remove excess resin prior to curing a CNT laden composite. Direct growth of CNT on various substrates can be limited due to the high temperatures often employed in CNT synthesis, which can impact the integrity of some substrates.

### SUMMARY OF THE INVENTION

In some aspects, embodiments disclosed herein relate to a system comprising a reusable substrate upon which a carbon nanostructure is formed in the system to provide a carbon nanostructure laden reusable substrate, a first conveyor system adapted to continuously convey the reusuable substrate through a carbon nanotube catalyst application station and carbon nanostructure growth station, and a second conveyor system adapted to create an interface between a second substrate and the carbon nanostructure-laden reusuable substrate, the interface facilitating transfer of a carbon nanostructure from the carbon nanostructure-laden reusuable substrate to the second substrate.

In other aspects, embodiments disclosed herein relate to a method comprising growing a carbon nanostructure on a reusable substrate, the carbon nanostructure comprising a carbon nanotube polymer having a structural morphology comprising interdigitation, branching, crosslinking, and shared walls and transferring the carbon nanostructure to a second substrate to provide a carbon nanostructure-laden second substrate, wherein the process is adapted for continuous carbon nanostructure production on the reusable substrate.

In yet other aspects, embodiments disclosed herein relate to a pre-preg comprising a carbon nanostructure, the carbon nanostructure comprising a carbon nanotube polymer having a structural morphology comprising interdigitation, branching, crosslinking, and shared walls.

### BRIEF DESCRIPTION OF THE DRAWINGS

FIG. 1 shows a schematic diagram of a system for preparing a carbon nanostructure (CNS) on a reusable substrate and transferring the CNS to a second substrate, in accordance with embodiments disclosed herein.

FIG. 2 shows a carbon nanostructure (CNS) or “flake” structure as a simplified rendering, in accordance with embodiments disclosed herein.

FIG. 3 shows a scanning electron micrograph (SEM) image of an authentic sample CNS structure, in accordance with embodiments disclosed herein.

FIG. 4 shows a catalyst having an anti-adhesion layer to facilitate CNS isolating from the substrate and/or catalyst, in accordance with embodiments disclosed herein.

### DETAILED DESCRIPTION

The present invention is directed, in part, to a continuous process for synthesizing a carbon nanostructure (CNS) on a reusable substrate and transferring the nascent CNS to a second substrate. CNS prepared on the reusable substrate can be transferred to a pre-preg material or other second substrate or otherwise isolated as a free standing CNS, i.e. free from association with a substrate, any of which may be introduced as filler materials in various composite applications. By way of example, the second substrate may be the final destination of the CNS and the resultant composite may be further converted into higher order composites by introducing the CNS-laden second substrate into a continuous phase matrix material. In other embodiments, the CNS-laden second substrate is a pre-preg. Alternatively, the CNS-laden second substrate may serve as a convenient storage device for the CNS and the CNS can be removed from the second substrate at a later time when needed. In still further embodiments, the CNS-laden second substrate can be used to transfer the CNS to a third substrate. In yet still further embodiments, the CNS-laden second substrate may be chopped at any desired interval to provide a CNS-laden chopped material, such as a CNS-laden chopped fiber.

Among the numerous advantages, the present invention provides a continuous process for producing a CNS on a reusable substrate allowing transfer to temperature sensitive second substrates which do not otherwise permit direct CNS synthesis thereon due to, for example, temperature-dependent degradation. For example, current processes that deposit carbon nanotubes directly onto a fiber surface require the heating of the fibers in a growth chamber and can result in fiber damage and lower the strength of the resultant composites. This system and methods disclosed herein do not require the heating of fibers and results in CNSs concentrated in the inter-ply regions where the composite tends to be weak. Current technology for producing carbon nanotube (CNT) infused composites either require the heating of fiber substrates or the dispersion of free CNTs in a resin. The drawback of these two processes include: (1) heating fiber substrates typically results in a loss of tensile strength; (2) a limited amount of CNTs, typically less than about 3%, can be dispersed in resin and (3) dispersing them can be complicated and ineffective.

The processes disclosed herein provide low cost, continuous production of CNS on a reuseable substrate for CNS growth and transfer to a useable medium, as exemplified by a pre-preg material. Indeed, the direct incorporation with manufacture of pre-preg materials provides a streamlined approach to such materials compared to processes typical in the art. The ability to prepare CNS structures with high volume and high rates provides further advantages to the system and methods disclosed herein.

Finally, the systems and methods disclosed herein enable the controlled of growth of CNS to optimize specific properties based on CNS length in order to target enhancements in, for example, electrical, mechanical, and thermal properties. Such property enhancements provide improvements across the composite industry, especially where mechanical properties are important. Structural multifunctional composites for land, sea, air and space become easily accessible.

In some embodiments, the present invention provides a system comprising a reusable substrate upon which a carbon nanostructure is formed in the system to provide a carbon nanostructure laden reusable substrate, a first conveyor system adapted to continuously convey the reusuable substrate through a carbon nanotube catalyst application station and carbon nanostructure growth station, and a second conveyor system adapted to create an interface between a second substrate and the carbon nanostructure-laden reusuable substrate, the interface facilitating transfer of a carbon nanostructure from the carbon nanostructure-laden reusuable substrate to the second substrate.

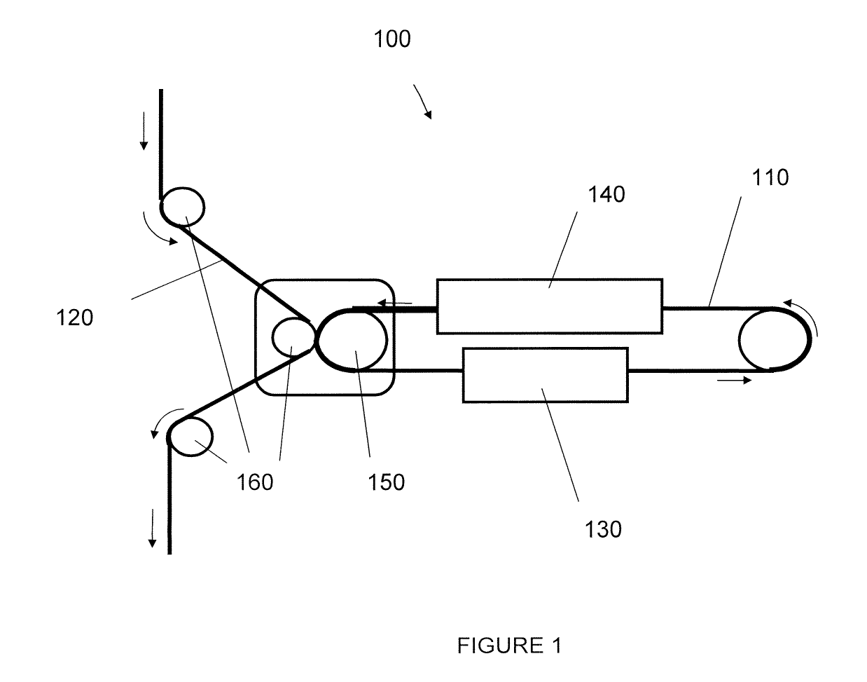

Referring now to FIG. 1, there is shown a system 100 in which CNS growth and transfer are incorporated into a single process continuously. System 100 includes a reusable substrate 110 as a scaffold for CNS preparation and second substrate 120 to receive the CNS from reusable substrate 110. Reusable substrate 110 can be reusable over any number of cycles, in some embodiments, or may be disposed of and/or recycled for other purposes, in other embodiments. In some embodiments, reusable substrate 110 can comprise a means for storing a CNS structure indefinitely until it is to be transferred to a second substrate. Reusable substrate 110 begins a CNS preparation cycle by passing through a CNT catalyst application station 130. Integrated with the catalyst application station or prior to the catalyst application station, there is an optional substrated cleaning station to prepare the substrate to receive catalyst. From there the catalyst-laden reusable substrate 110 is delivered to CNS growth station 140 where the CNS is formed on reusable substrate 110. Conveyor system 150 delivers the CNS-laden reusable substrate to second substrate 120, second substrate 120 being conveyed by a plurality of rollers 160, for example. In the embodiments shown in FIG. 1, one of the plurality of rollers 160 contacts the conveyor system 150 to transfer the CNS structure to the second substrate. One skilled in the art will recognize that any number of interceding steps may be introduced prior to this contact point to facilitate CNS transfer. For example, in some embodiments, the CNS may undergo a loosening step with an air knife to facilitate transfer from reusable substrate 110 to second substrate 120. In some embodiments, more than one of the plurality of rollers 160 may contact conveyor system 150 providing multiple contact points between reusable substrate 110 to second substrate 120 to facilitate transfer.

In some embodiments, systems disclosed herein employ a reusable substrate that comprises a fiber material or a sheet. In some such embodiments, reusable substrate 110 is a spread wire tow substrate. This can have the advantage of providing less diffusion and a greater surface area to provide greater CNS density. The large channels of a spread tow provides more space to diffuse carbon feedstock gas, for example. In some embodiments, reusable substrate 110 can be a metallic sheet or belt, such as steel coated with aluminum, Al. In some embodiments, the steel is a high melting commercial steel sheet. In some embodiments, the CNS formed can be removed from reusable substrate 110 and directly isolated as loose CNS structures. In some such embodiments, the CNS structure can be collected by blowing or wiping off the resusable substrate. In some embodiments removal of the CNS from reusable substrate 110 employs mechanical means, such as sonication (with or without liquid), microwave radiation, or chemical treatment. In some embodiments, the CNS structures is collection directly into a solution. In some embodiments, the CNS formed on the reusable substrate can be transferred to second substrate 120 that is a fiber-pre-preg-woven fabric with resin.

In some embodiments, system disclosed herein provide a carbon nanostructure growth station which comprises a microcavity. In some such embodiments, the carbon nanostructure growth station allows synthesis of the carbon nanostructure on the reusable substrate at a growth rate of several microns per second. Without being bound by theory, it has been indicated that the crosslinking and branching of CNTs during growth resulting in the CNS structure can greatly enhanced by a small growth cavity providing greater chances for productive chemistry in CNT growth. The resulting CNS structure appears as a highly crosslinked and branched polymer of carbon nanotubes. The CNS structure substantially departs from conventional CNT forests which typically are grown under substantially slower growth rates and don't provide the large degree of crosslinking and branching. In some embodiments, the CNS structure may also be favored by inclusion of a gas pre-heater in the system to provide carbon feedstock gases at temperatures which promote CNT synthesis as the carbon feedstock enters the microcavity. In this way, reactive intermediates, confined in the small cavity reactor encounter the CNT growth catalyst and non-productive side reaction chemistry may be minimized.

In some embodiments, systems disclose herein may further comprise an anti-adhesive coating station. Such a station may be disposed before or after the catalyst application station. The function of such a station can be to facilitate CNS transfer to the second substrate. In some embodiments, the anti-adhesive is provided on the CNT growth catalyst itself. In some embodiments, the anti-adhesive coating may comprise a silane, alumina, or the like. In some embodiments, the anti-adhesive coating may also provide a means by which to reduce the mobility of the CNT growth catalyst on the surface of the reusable substrate and reduce agglomerization of the catalyst into larger particles.

In some embodiments, systems disclosed herein may be particularly suited to utilize a second substrate that is a pre-preg. In some such embodiments, the pre-preg can be impregnated with the CNS structure and then subsequently delivered to a curing station or to a composite forming station. In some embodiments, the pre-preg may be a so-called B-stage pre-preg comprising a partially cured matrix material.

In some embodiments, systems disclosed herein may further comprise a carbon nanostructure modification station. Such a station or multiple stations may perform chemistries on the nascent carbon nanostructure. Such reactions may include, without limitation, oxidation, reduction, fluorination, and the like. In some embodiments, the modification station may comprise an oxidation station to provide organic functional group handles on the CNS structures, such as carboxylic acid groups.

In some embodiments, the present invention provides a method comprising growing a carbon nanostructure on a reusable substrate, the carbon nanostructure comprising a carbon nanotube polymer having a structural morphology comprising interdigitation, branching, crosslinking, and shared walls, and transferring the carbon nanostructure to a second substrate to provide a carbon nanostructure-laden second substrate, wherein the process is adapted for continuous carbon nanostructure production on the reusable substrate. In some embodiments, methods disclosed herein provides reusable substrates that are fiber materials or a sheets, as described above.

In some embodiments, methods disclosed herein may further comprise comprising applying a carbon nanotube growth catalyst to the reusable substrate. In other embodiments, methods of the invention may further comprise applying an anti-adhesive coating to the reusable substrate. In some embodiments, method disclosed herein are particularly suited to employing a second substrate that is a pre-preg or stage B cured resin film. In some embodiments, methods disclosed herein may further comprise transferring the carbon nanostructure from the second substrate to a third substrate. In this regard, the second substrate may be designed solely for the purpose of convenient storage of the CNS structure for shipping and the like. In some embodiments, methods disclosed herein may further comprise chopping the second substrate after transferring the carbon nanostructure to the second substrate. In some such embodiments, the second substrate is a fiber material and the resultant CNS-laden chopped fiber material may be formed into a chopped strand mat. In some embodiments, the CNS-laden second substrate may be formed into mold and a matrix material delivered into the mold to form a composite upon curing of the matrix material.

In some embodiments, the present invention provides a pre-preg comprising a carbon nanostructure, the carbon nanostructure comprising a carbon nanotube polymer having a structural morphology comprising interdigitation, branching, crosslinking, and shared walls. The pre-preg may be any commercial structure even low temperature curing pre-pregs. In this regard, the CNS transfer from the reusuable substrate can provide a very mild set of conditions to dispose the CNS on the pre-preg without concern for premature curing.

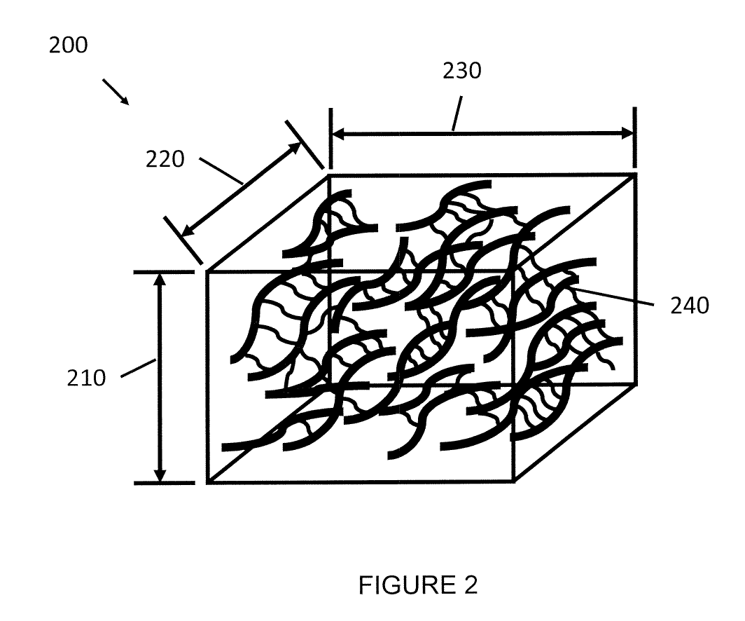

The following discussion is provided as a general description of the CNS structure which is quite different in appearance from conventional carbon nanotube forests and similar CNT arrays known in the art. Referring to FIG. 2 there is shown a diagram of the CNS 200 as a flake-like microstructure, the flake being isolated after growth of the CNS on a suitable substrate and subsequently removed from the substrate. The basic flake can have a first dimension 210 that is in a range from about 1 nanometer (nm) to about 500 nm thick, including any value inbetween and fractions thereof. The basic flake can have a second dimension 220 that is in a range from about 1 micron to about 750 microns tall, including any value inbetween and fractions thereof. The basic flake dimensions can have a third dimension 230 that is only limited in size based on the length of a substrate on which the CNS is grown. For example, the process for growing CNS on a substrate can be accomplished with a tow or roving of a fiber-based material. The process is continuous and the CNS can extend the entire length of a spool of fiber. Thus, by way of example, third dimension 230 can be in a range from about 1 meter (m) to about 10,000 m wide. Again, this dimension can be very long because it represents the dimension that runs along the axis of the substrate upon which the CNS is prepared and this can be accomplished on a continuously fed substrate such as a fiber tow or roving, a tape, sheet, or the like. Clearly, third dimension 230 can also be cut to any desired length less than 1 meter. For example, in some embodiments, third dimension 230 can on the order of about 1 to about 10 microns, about 100 to about 500 microns, about 100 to about 500 cm, and so on, up to any desired length, including any amount between the recited ranges and fractions thereof. The CNS polymer-like structure is thus provided as a continuous layer on whatever substrate type upon which it is grown which, in turn, can provide materials of exceptionally high molecular weight.

CNS 200 comprises a webbed network of CNTs 240 in the form of a carbon nanotube polymer (or “carbon nanopolymer”) which may have a molecular weight in a range from about 15,000 g/mol to about 150,000 g/mol, including all values inbetween and fractions thereof. The upper end of the molecular weight can be even higher, including 200,000 g/mol, 500,000 g/mol, and 1,000,000 g/mol. In some embodiments, the molecular weight may be a function of the predominant diameter and number of walls of CNTs within the carbon nanostructure web. CNS 200 disclosed herein can have a cross link density in a range from about 2 mol/cm³ to about 80 mol/cm³. The crosslinking density may be a function of CNS growth density on the surface of the substrate as well as CNS growth conditions.

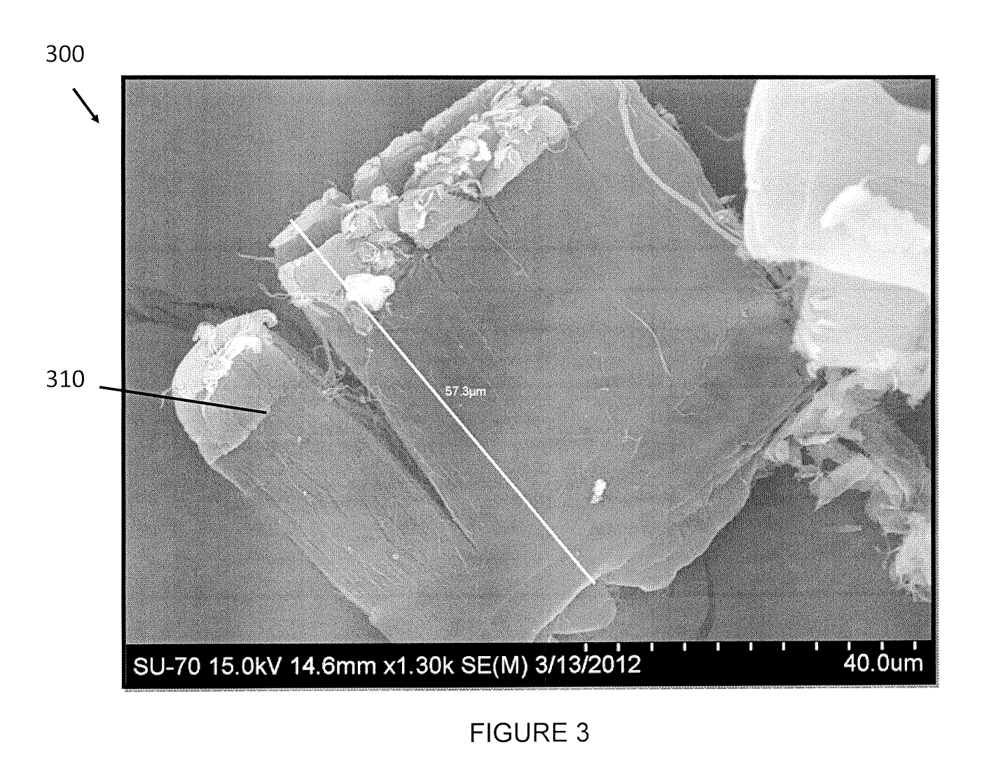

CNS 200 comprise a network of highly interdigitated, entangled, and cross-linked networks of carbon nanotubes (CNTs) 240 which are grown as robust coatings on substrates such as composite fibers and can be extracted and isolated as a flake-like material as shown in the artistic rendering of FIG. 2 and the SEM image 300 of an authentic sample of CNS 310 shown in FIG. 3. CNS 310 exists as a three dimensional microstructure due to the entanglement and cross-linking of highly aligned CNTs. The aligned morphology is reflective of the synthesis having been performed on a substrate, i.e. the CNS network grows perpendicularly from the substrate surface. Without being bound by theory, it has been postulated that the rapid rate of CNT synthesis conditions, which may approach several microns per second, may contribute, in part, to the complex CNS morphology.

The isolated CNS 200 and 300 can demonstrate superior dispensability in a matrix material and impart improved electrical percolation and thermal response compared to conventional bulk CNT powders. Improved dispersibility and performance observed relative to multi-walled carbon nanotubes (MWNTs) is shown in the plot in FIG. 3. The data shows that as low as ⅕ the mass percentage of CNS relative to MWNTs can be used to provide the same volume resistivity performance. One skilled in the art will recognize the low impact in the differing matrix materials in this example.

The CNS morphology can be accessed via CNT growth conditions, which are detailed herein further below. The density of the CNS flake product can be tightly modulated by the CNT growth conditions, including, for example, the concentration of the catalyst particles disposed on the substrate. Advantageously, the crosslinking does not require any post CNT modification reactions to effect crosslinking such as chemical etching and other chemical modifications which can erode the beneficial CNT properties. The CNS structure is believe to result from the rapid growth of the CNS on the substrate. While a conventional CNT growth process typically taking several minutes employing most growth techniques, the CNS process employs a nominal CNT growth rate on the order of seconds in a continuous in situ process. As a result, the structure is more defective, containing highly entangled, branched, and cross-linked CNTs. While the focus of the skilled artisan has been mainly on high purity growth which requires higher temperatures and longer synthesis times, the in situ, continuous growth process for CNS growth synthesizes CNTs at such a rapid rate that it creates a branched and crosslinked CNT network that is CNS. Moreover, the ability to grow the CNS structure continuously on a substrate provides access to quantities of CNS flake that are difficult to access via conventional CNT preparations. The preparation of the CNS on a substrate helps to avoid CNT bundling which is observed when working with individualized CNTs. In some embodiments, bundling can be controlled via alignment of growth and size (length) of the CNS on the substrate.

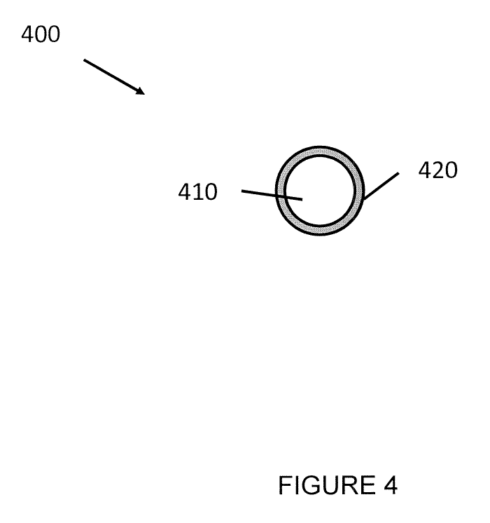

In some embodiments, one mode for catalyst application is through particle adsorption with catalyst application including, for example liquid or colloidal precursor-based application. Suitable catalysts materials can include any d-block transition metal or d-block transition metal salt. In some embodiments, metal salts can be applied without thermal treatments. As indicated in FIG. 4, in some embodiments, a coated-catalyst 400 can include a core catalyst particle 410 with an anti-adhesive layer 420. In some embodiments, colloidal particle solutions can be used in which an exterior layer about the catalyst nanoparticle which promotes substrate to particle adhesion but prevents CNS to particle adhesion.

The following description is provided as further guidance to the skilled artisan for producing carbon nanostructures (CNS) on reusable substrates of the present invention. It will be recognized by those skilled in the art, that embodiments describing the preparation of carbon nanostructures on metal fiber disclosed below is merely exemplary. For example, similar materials bearing carbon nanostructures can be prepared on other materials, including other fiber materials, by similar methods. It is to be understood that the forgoing discussion uses the terms CNS and CNT interchangeably, as the exact nature of the CNS product is complex, but has as it primary structural element the carbon nanotube.

In some embodiments, the present invention utilizes metal fiber tow materials as the reusable substrate. Thus, the present disclosure is directed, in part, to CNSs synthesis on metal fiber materials. The processes described herein allow for the continuous production of carbon nanotubes of uniform length and distribution along spoolable lengths of tow, roving, tapes, fabrics, meshes, perforated metal sheets, solid metal sheets, and ribbons. While various mats, woven and non-woven fabrics and the like can be functionalized by processes of the invention, it is also possible to generate such higher ordered structures from the parent roving, tow, yarn or the like after CNT functionalization of these parent materials. For example, a CNT-infused chopped strand mat can be generated from a CNT-infused metal fiber roving. As used herein the term “metal fiber material” refers to any material which has metal fiber as its elementary structural component. The term encompasses, fibers, filaments, yarns, tows, tapes, woven and non-woven fabrics, plies, mats, and meshes.

As used herein the term “spoolable dimensions” refers to metal fiber materials having at least one dimension that is not limited in length, allowing for the material to be stored on a spool or mandrel. Metal fiber materials of “spoolable dimensions” have at least one dimension that indicates the use of either batch or continuous processing for CNT infusion as described herein. One metal fiber material of spoolable dimensions that is commercially available is exemplified by Stainless Steel metal fiber wire with a tex value of 8706 (1 tex=1 g/1,000 m) or 57 yard/lb (Mechanical Metals, Inc., Newton, Pa.). Commercial metal fiber roving, in particular, can be obtained on 1 oz, ¼, ½, 1, 5, 10, 25 lb, and greater spools, for example. Processes of the invention operate readily with 1 to 25 lb. spools, although larger spools are usable. Moreover, a pre-process operation can be incorporated that divides very large spoolable lengths, for example 100 lb. or more, into easy to handle dimensions, such as two 50 lb spools.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTS), multi-walled carbon nanotubes (MWNTs). CNTs can be capped by a fullerene-like structure or open-ended. CNTs include those that encapsulate other materials.

As used herein “uniform in length” refers to length of CNTs grown in a reactor. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length. Although uniformity in CNT length can be obtained across the entirety of any length of spoolable metal fiber material, processes of the invention also allow the CNT length to vary in discrete sections of any portion of the spoolable material. Thus, for example, a spoolable length of metal fiber material can have uniform CNT lengths within any number of sections, each section not necessarily having the same CNT length. Such sections of different CNT length can appear in any order and can optionally include sections that are void of CNTs. Such control of CNT length is made possible by varying the linespeed of the process, the flow rates of the carrier and carbon feedstock gases and reaction temperatures. All these variables in the process can be automated and run by computer control.

As used herein “uniform in distribution” refers to the consistency of density of CNTs on a metal fiber material. “Uniform distribution” means that the CNTs have a density on the metal fiber material with tolerances of plus or minus about 10% coverage defined as the percentage of the surface area of the fiber covered by CNTs. This is equivalent to ±1500 CNTs/μm2 for an 8 nm diameter CNT with 5 walls. Such a figure assumes the space inside the CNTs as fillable.

As used herein, the term “infused” means bonded and “infusion” means the process of bonding. Such bonding can involve direct covalent bonding, ionic bonding, pi-pi, and/or van der Waals force-mediated physisorption or mechanical interlocking. For example, CNTs may be infused directly to the metal fiber. Infusion can also involve indirect bonding, such as the indirect CNT infusion to the metal fiber via bonding to a barrier coating and/or an intervening transition metal nanoparticle disposed between the CNTs and metal fiber material. The particular manner in which a CNT is “infused” to a metal fiber material is referred to as a “bonding motif.” In some embodiments, infusion may be of a strength so as not to prevent the transfer of the CNT-containing network from the reusable substrate to the second substrate.

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, serve as catalysts for CNT growth on the metal fiber materials.

As used herein, the term “matrix material” refers to a bulk material than can serve to organize sized CNT-infused metal fiber materials in particular orientations, including random orientation. The matrix material can benefit from the presence of the CNT-infused metal fiber material by imparting some aspects of the physical and/or chemical properties of the CNT-infused metal fiber material to the matrix material.

As used herein, the term “material residence time” refers to the amount of time a discrete point along a glass fiber material of spoolable dimensions is exposed to CNT growth conditions during the CNT infusion processes described herein. This definition includes the residence time when employing multiple CNT growth chambers.

As used herein, the term “linespeed” refers to the speed at which a glass fiber material of spoolable dimensions can be fed through the CNT infusion processes described herein, where linespeed is a velocity determined by dividing CNT chamber(s) length by the material residence time.

In some embodiments, the present invention provides a composition that includes a carbon nanotube (CNT)-infused metal fiber material. The CNT-infused metal fiber material includes a metal fiber material of spoolable dimensions, a barrier coating conformally disposed about the metal fiber material, and carbon nanotubes (CNTs) infused to the metal fiber material. The infusion of CNTs to the metal fiber material can include a bonding motif of direct bonding of individual CNTs to a transition metal NP. The NPs, in turn, can be infused to the metal fiber material, the barrier coating, and mixtures thereof.

Without being bound by theory, transition metal NPs, which serve as a CNT-forming catalyst, can catalyze CNT growth by forming a CNT growth seed structure. The CNT-forming catalyst can remain at the base of the metal fiber material, locked by the barrier coating, and infused to the surface of the metal fiber material. In such a case, the seed structure initially formed by the transition metal nanoparticle catalyst is sufficient for continued non-catalyzed seeded CNT growth without the catalyst moving along the leading edge of CNT growth, as often observed in the art. In some embodiments, the CNT growth catalyst can follow the leading edge of the growing CNTs despite the presence of a barrier coating. In such embodiments, the CNT growth nanoparticle catalyst is disposed distal to the fiber and the CNT can infuse either directly to the metal fiber or to the barrier coating. In other embodiments, the nanoparticle serves as a point of attachment for the CNT to the metal fiber material. The presence of the barrier coating can also lead to further indirect bonding motifs. For example, the CNT forming catalyst can be locked into the barrier coating, as described above, but not in surface contact with metal fiber material. In such a case a stacked structure with the barrier coating disposed between the CNT forming catalyst and metal fiber material results. In either case, the CNTs formed are infused, albeit indirectly, to the metal fiber material. Regardless of the nature of the actual bonding motif formed between the carbon nanotubes and the metal fiber material, the infused CNT is robust and allows the CNT-infused metal fiber material to exhibit carbon nanotube properties and/or characteristics.

Again, without being bound by theory, when growing CNTs on metal fiber materials, the elevated temperatures and/or any residual oxygen and/or moisture that can be present in the reaction chamber can damage the metal fiber material, although standard measures to minimize such exposure are generally practiced. These issues can be considerable when the metal fiber material is a zero-valent metal that is vulnerable to oxidation. Moreover, the metal fiber material itself can be altered by reaction with the CNT-forming catalyst. That is the metal fiber material can form an alloy with the catalyst at the reaction temperatures employed for CNT synthesis. The CNT-forming nanoparticle catalysts are also vulnerable to high temperature sintering on the surface metal fiber material. This is because the surface structure of metals facilitates particle transport at the surface at the high temperatures employed in CNT synthesis. The barrier coating employed in the invention is designed to facilitate CNT synthesis on metal fiber materials, in addition to preventing sintering and/or alloying of the catalyst on the metal surface. Without being bound by theory, the barrier coating can provide a thermal barrier for use with low melting metal fiber material substrates such as zinc, aluminum, lead, and tin, for example. This thermal protection can also help reduce the formation of alloys. Furthermore, the barrier coating can also provide a physical barrier preventing sintering of the CNT-forming catalyst nanoparticles at the elevated temperatures by restricting movement of the catalyst nanoparticles on the surface of the metal fiber material. Additionally, the barrier coating can minimize the surface area contact between the CNT-forming catalyst and the metal fiber material and/or it can mitigate the effects of the exposure of the metal fiber material to the CNT-forming catalyst at CNT growth temperatures.

Compositions having CNT-infused metal fiber materials are provided in which the CNTs are substantially uniform in length. In the continuous process described herein, the residence time of the metal fiber material in a CNT growth chamber can be modulated to control CNT growth and ultimately, CNT length. This provides a means to control specific properties of the CNTs grown. CNT length can also be controlled through modulation of the carbon feedstock and carrier gas flow rates, and growth temperature. Additional control of the CNT properties can be obtained by controlling, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNT-infused metal fiber material with uniformly distributed CNTs on metal fiber materials while avoiding bundling and/or aggregation of the CNTs that can occur in processes in which pre-formed CNTs are suspended or dispersed in a solvent solution and applied by hand to the metal fiber material. Such aggregated CNTs tend to adhere weakly to a metal fiber material and the characteristic CNT properties are weakly expressed, if at all. In some embodiments, the maximum distribution density, expressed as percent coverage, that is, the surface area of fiber covered, can be as high as about 55%, assuming about 8 nm diameter CNTs with 5 walls. This coverage is calculated by considering the space inside the CNTs as being “fillable” space. Various distribution/density values can be achieved by varying catalyst dispersion on the surface as well as controlling gas composition, linespeed of the process, and reaction temperatures. Typically for a given set of parameters, a percent coverage within about 10% can be achieved across a metal fiber material surface. Higher density and shorter CNTs are useful for improving mechanical properties, while longer CNTs with lower density are useful for improving thermal and electrical properties, although increased density is still favorable. A lower density can result when longer CNTs are grown. This can be the result of employing higher temperatures and more rapid growth causing lower catalyst particle yields.

The compositions of the invention having CNT-infused metal fiber materials can include a metal fiber material such as a metal filament, a metal fiber yarn, a metal fiber tow, a metal tape, a metal fiber-braid, a woven metal fabric, a non-woven metal fiber mat, a metal fiber ply, meshes ribbons, solid metal sheets, and perforated metal sheets. Metal filaments include high aspect ratio fibers having diameters ranging in size from between about 10 microns to about 12.5 mm or greater. Metal fiber tows are generally compactly associated bundles of filaments and are usually twisted together to give ropes.

Ropes include closely associated bundles of twisted filaments. Each filament diameter in a ropes is relatively uniform. Ropes have varying weights described by their ‘tex,’ expressed as weight in grams of 1000 linear meters, or denier, expressed as weight in pounds of 10,000 yards, with a typical tex range usually being between about 4000 tex to about 100000 tex.

Tows include loosely associated bundles of untwisted filaments. As in ropes, filament diameter in a tow is generally uniform. Tows also have varying weights and the tex range is usually between 2000 g and 12000 g. They are frequently characterized by the number of thousands of filaments in the tow, for example 10 wire rope, 50 wire rope, 100 wire rope, and the like.

Metal meshes are materials that can be assembled as weaves or can represent non-woven flattened ropes. Metal tapes can vary in width and are generally two-sided structures similar to ribbon. Processes of the present invention are compatible with CNT infusion on one or both sides of a tape. CNT-infused tapes can resemble a “carpet” or “forest” on a flat substrate surface. Again, processes of the invention can be performed in a continuous mode to functionalize spools of tape.

Metal fiber-braids represent rope-like structures of densely packed metal fibers. Such structures can be assembled from ropes, for example. Braided structures can include a hollow portion or a braided structure can be assembled about another core material.

In some embodiments a number of primary metal fiber material structures can be organized into fabric or sheet-like structures. These include, for example, woven metal meshes non-woven metal fiber mat and metal fiber ply, in addition to the tapes described above. Such higher ordered structures can be assembled from parent tows, ropes, filaments or the like, with CNTs already infused in the parent fiber. Alternatively such structures can serve as the substrate for the CNT infusion processes described herein.

Metals fiber materials can include any metal in zero-valent oxidation state including, for example, d-block metals, lanthanides, actinides, main group metals and the like. Any of these metals can also be used in non-zero-valent oxidation state, including, for example, metal oxides, metal nitrides, and the like. Exemplary d-block metals include, for example, scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, and gold. Exemplary main group metals include, for example, aluminum, gallium, indium, tin, thallium, lead, and bismuth. Exemplary metal salts useful in the invention include, for without limitation, oxides, carbides, nitrides, and acetates.

CNTs useful for infusion to metal fiber materials include single-walled CNTs, double-walled CNTs, multi-walled CNTs, and mixtures thereof. The exact CNTs to be used depends on the application of the CNT-infused metal fiber. CNTs can be used for thermal and/or electrical conductivity applications, or as insulators. In some embodiments, the infused carbon nanotubes are single-wall nanotubes. In some embodiments, the infused carbon nanotubes are multi-wall nanotubes. In some embodiments, the infused carbon nanotubes are a combination of single-wall and multi-wall nanotubes. There are some differences in the characteristic properties of single-wall and multi-wall nanotubes that, for some end uses of the fiber, dictate the synthesis of one or the other type of nanotube. For example, single-walled nanotubes can be semi-conducting or metallic, while multi-walled nanotubes are metallic.

CNTs lend their characteristic properties such as mechanical strength, low to moderate electrical resistivity, high thermal conductivity, and the like to the CNT-infused metal fiber material. For example, in some embodiments, the electrical resistivity of a carbon nanotube-infused metal fiber material is lower than the electrical resistivity of a parent metal fiber material. The infused CNTs can also provide beneficial conductivity with lighter weights. Moreover, the use of shorter CNTs can be used to provide a greater tensile strength, while also improving electrical conductivity. More generally, the extent to which the resulting CNT-infused fiber expresses these characteristics can be a function of the extent and density of coverage of the metal fiber by the carbon nanotubes. Any amount of the fiber surface area, from 0-55% of the fiber can be covered assuming an 8 nm diameter, 5-walled MWNT (again this calculation counts the space inside the CNTs as fillable). This number is lower for smaller diameter CNTs and more for greater diameter CNTs. 55% surface area coverage is equivalent to about 15,000 CNTs/micron2. Further CNT properties can be imparted to the metal fiber material in a manner dependent on CNT length, as described above. Infused CNTs can vary in length ranging from between about 1 micron to about 500 microns, including 1 micron, 2 microns, 3 microns, 4 micron, 5, microns, 6, microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, 150 microns, 200 microns, 250 microns, 300 microns, 350 microns, 400 microns, 450 microns, 500 microns, and all values in between. CNTs can also be less than about 1 micron in length, including about 0.5 microns, for example. CNTs can also be greater than 500 microns, including for example, 510 microns, 520 microns, 550 microns, 600 microns, 700 microns and all values in between.

Compositions of the invention can incorporate CNTs having a length from about 1 micron to about 10 microns. Such CNT lengths can be useful in application to increase shear strength. CNTs can also have a length from about 5-70 microns. Such CNT lengths can be useful in application to increase tensile strength if the CNTs are aligned in the fiber direction. CNTs can also have a length from about 10 microns to about 100 microns. Such CNT lengths can be useful to increase electrical/thermal and mechanical properties. The process used in the invention can also provide CNTs having a length from about 100 microns to about 500 microns, which can also be beneficial to increase electrical and thermal properties. One skilled in the art will recognize that the properties imparted are a continuum and that some tensile strength benefits can still be realized at longer CNT lengths. Likewise, shorter CNT lengths can still impart beneficial electrical properties as well. Control of CNT length is readily achieved through modulation of carbon feedstock and carrier gas flow rates coupled with varying process linespeeds and reaction temperatures, as described further below.

In some embodiments, compositions that include spoolable lengths of CNT-infused metal fiber materials can have various uniform regions with different lengths of CNTs. For example, it can be desirable to have a first section of CNT-infused metal fiber material with uniformly shorter CNT lengths to enhance tensile and shear strength properties, and a second section of the same spoolable material with a uniform longer CNT length to enhance electrical or thermal properties.

Processes of the invention for CNT infusion to metal fiber materials allow control of the CNT lengths with uniformity and in a continuous process allowing spoolable metal fiber materials to be functionalized with CNTs at high rates. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time of about 5 to about 300 seconds in a CNT growth chamber can produce CNTs having a length between about 1 micron to about 10 microns. In some embodiments, a material residence time of about 30 to about 180 seconds in a CNT growth chamber can produce CNTs having a length between about 10 microns to about 100 microns. In still other embodiments, a material residence time of about 180 to about 300 seconds can produce CNTs having a length between about 100 microns to about 500 microns. One skilled in the art will recognize that these numbers are approximations and that growth temperature and carrier and carbon feedstock flow rates can also impact CNT growth for a given material residence time. For example, increased temperatures typically increase the overall growth rate requiring less material residence time for a desired CNT length. Increased carbon feedstock flow rate ratio (inert to carbon feedstock) can also increase growth rates although this effect is less than changing the growth temperature.

CNT-infused metal fiber materials of the invention include a barrier coating. Barrier coatings can include for example an alkoxysilane, such as methylsiloxane, an alumoxane, alumina nanoparticles, spin on glass and glass nanoparticles. As described below, the CNT-forming catalyst can be added to the uncured barrier coating material and then applied to the metal fiber material together. In other embodiments the barrier coating material can be added to the metal fiber material prior to deposition of the CNT-forming catalyst. The barrier coating material can be of a thickness sufficiently thin to allow exposure of the CNT-forming catalyst to the carbon feedstock for subsequent CVD growth. In some embodiments, the thickness is less than or about equal to the effective diameter of the CNT-forming catalyst. In some embodiments, the thickness is between about 10 nm and about 100 nm. In some embodiments, the thickness can be less than 10 nm, including 1 nm, 2 nm, 3 nm, 4 nm, 5 nm, 6 nm, 7 nm, 8 nm, 9 nm, and any value in between.

Without being bound by theory, the barrier coating can serve as an intermediate layer between the metal fiber material and the CNTs and serves to mechanically infuse the CNTs to the metal fiber material via a locked CNT-forming catalyst nanoparticle that serves as a site CNT growth. Such mechanical infusion provides a robust system in which the metal fiber material serves as a platform for organizing the CNTs while still imparting properties of the CNTs to the metal fiber material. Moreover, the benefit of including a barrier coating is the immediate protection it provides the metal fiber material from chemical damage due to exposure to moisture, oxygen and any thermal effects of alloying, sintering, or the like when heating the metal fiber material at the temperatures used to promote CNT growth.

The infused CNTs can improve the fiber-to-matrix interface in composite materials and, more generally, improve fiber-to-fiber interfaces. Indeed, the CNT-infused metal fiber materials disclosed herein are themselves composite materials in the sense the CNT-infused metal fiber material properties will be a combination of those of the metal fiber material as well as those of the infused CNTs. Consequently, embodiments of the present invention provide a means to impart desired properties to a metal fiber material that otherwise lack such properties or possesses them in insufficient measure. Metal fiber materials can be tailored or engineered to meet the requirements of specific applications. The CNTs behave as a sizing to protect metal fiber materials from absorbing moisture due to the hydrophobic CNT structure, although sizing agents are not commonly employed with metal fibers. Moreover, hydrophobic matrix materials, as further exemplified below, interact well with hydrophobic CNTs to provide improved fiber to matrix interactions.

Compositions of the present invention can further include a matrix material to form a composite with the CNT-infused metal fiber material. Such matrix materials can include, for example, an epoxy, a polyester, a vinylester, a polyetherimide, a polyetherketoneketone, a polyphthalamide, a polyetherketone, a polytheretherketone, a polyimide, a phenol-formaldehyde, and a bismaleimide. Matrix materials useful in the present invention can include any of the known matrix materials (see Mel M. Schwartz, Composite Materials Handbook (2d ed. 1992)). Matrix materials more generally can include resins (polymers), both thermosetting and thermoplastic, metals, ceramics, and cements.

Thermosetting resins useful as matrix materials include phthalic/maelic type polyesters, vinyl esters, epoxies, phenolics, cyanates, bismaleimides, and nadic end-capped polyimides (e.g., PMR-15). Thermoplastic resins include polysulfones, polyamides, polycarbonates, polyphenylene oxides, polysulfides, polyether ether ketones, polyether sulfones, polyamide-imides, polyetherimides, polyimides, polyarylates, and liquid crystalline polyester.

Metals useful as matrix materials include alloys of aluminum such as aluminum 6061, 2024, and 713 aluminum braze. Ceramics useful as matrix materials include carbon ceramics, such as lithium aluminosilicate, oxides such as alumina and mullite, nitrides such as silicon nitride, and carbides such as silicon carbide. Cements useful as matrix materials include carbide-base cements (tungsten carbide, chromium carbide, and titanium carbide), refractory cements (tungsten-thoria and barium-carbonate-nickel), chromium-alumina, nickel-magnesia iron-zirconium carbide. Any of the above-described matrix materials can be used alone or in combination.

Applications that use CNT-infused metal fibers are numerous. Exemplary applications include, without limitation, photovoltaic devices, semiconducting materials, decreasing resistivity, powerlines, dampening characteristics, audio speaker systems, EMI shielding, solar collectors, electrodes for batteries, supercapacitors, data cable fiber. rf cabling, and coaxial cables. CNT-infused metal fiber materials can enhance structural elements in numerous industries including, for example, automotive, sports and leisure equipment, aerospace and ballistics applications, and the like.

In some embodiments the present invention provides a continuous process for CNT infusion that includes (a) disposing a carbon nanotube-forming catalyst on a surface of a glass fiber material of spoolable dimensions; and (b) synthesizing carbon nanotubes directly on the glass fiber material, thereby forming a carbon nanotube-infused glass fiber material. For a 9 foot long system, the linespeed of the process can range from between about 1.5 ft/min to about 108 ft/min. The linespeeds achieved by the process described herein allow the formation of commercially relevant quantities of CNT-infused glass fiber materials with short production times. For example, at 36 ft/min linespeed, the quantities of CNT-infused glass fibers (over 5% infused CNTs on fiber by weight) can exceed over 250 pound or more of material produced per day in a system that is designed to simultaneously process 5 separate rovings (50 lb/roving). Systems can be made to produce more rovings at once or at faster speeds by repeating growth zones. Moreover, some steps in the fabrication of CNTs, as known in the art, have prohibitively slow rates preventing a continuous mode of operation. For example, in a typical process known in the art, a CNT-forming catalyst reduction step can take 1-12 hours to perform. The process described herein overcomes such rate limiting steps.

The linespeeds achievable using processes of the invention are particular remarkable when considering that some steps in the fabrication of CNTs, as known in the art, have otherwise prohibitively slow rates, thus preventing a continuous mode of operation. For example, in a typical process known in the art, a CNT-forming catalyst reduction step can take 1-12 hours to perform. CNT growth itself can also be time consuming, for example requiring tens of minutes for CNT growth, precluding the rapid linespeeds realized in the present invention. The process described herein overcomes such rate limiting steps.

The CNT-infused metal fiber material-forming processes of the invention can avoid CNT entanglement that occurs when trying to apply suspensions of pre-formed carbon nanotubes to fiber materials. That is, because pre-formed CNTs are not fused to the metal fiber material, the CNTs tend to bundle and entangle. The result is a poorly uniform distribution of CNTs that weakly adhere to the metal fiber material. However, processes of the present invention can provide, if desired, a highly uniform entangled CNT mat on the surface of the metal fiber material by reducing the growth density. The CNTs grown at low density are infused in the metal fiber material first. In such embodiments, the fibers do not grow dense enough to induce vertical alignment, the result is entangled mats on the metal fiber material surfaces. By contrast, manual application of pre-formed CNTs does not insure uniform distribution and density of a CNT mat on the metal fiber material.

A process for producing CNT-infused metal fiber material includes at least the operations of 1) functionalizing a metal fiber material to be receptive to barrier coating; 2) applying a barrier coating and a CNT-forming catalyst to the metal fiber material; 3) heating the metal fiber material to a temperature that is sufficient for carbon nanotube synthesis; and 4) Synthesizing CNTs by CVD-mediated growth on the catalyst-laden metal fiber.

To prepare a metal fiber material for barrier coating, functionalizing the metal fiber material is performed. In some embodiments, functionalizing the metal fiber material can include a wet chemical oxidative etch to create reactive functional groups (metal oxo and/or hydroxyl groups) on the metal fiber material surface. This can be particularly useful when using zero-valent metals to create a surface oxide layer. In other embodiments, functionalizing can include a plasma process, which may serve a dual role of creating functional groups as described above, and roughening the metal fiber material surface to enhance the surface area and wetting properties of the metal fiber material, including the deposition of the barrier coating. To infuse carbon nanotubes into a metal fiber material, the carbon nanotubes are synthesized on a metal fiber material which is conformally coated with a barrier coating. In one embodiment, this is accomplished by conformally coating the metal fiber material with a barrier coating and then disposing carbon nanotube-forming catalyst on the barrier coating. In some embodiments, the barrier coating can be partially cured prior to catalyst deposition. This can provide a surface that is receptive to receiving the catalyst and allowing it to embed in the barrier coating, including allowing surface contact between the CNT forming catalyst and the metal fiber material. In such embodiments, the barrier coating can be fully cured after embedding the catalyst. In some embodiments, the barrier coating is conformally coated over the metal fiber material simultaneously with deposition of the CNT-form catalyst. Once the CNT-forming catalyst and barrier coating are in place, the barrier coating can be fully cured.

In some embodiments, the barrier coating can be fully cured prior to catalyst deposition. In such embodiments, a fully cured barrier-coated metal fiber material can be treated with a plasma to prepare the surface to accept the catalyst. For example, a plasma treated metal fiber material having a cured barrier coating can provide a roughened surface in which the CNT-forming catalyst can be deposited. The plasma process for “roughing” the surface of the barrier coating thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, nitrogen, and hydrogen. In order to treat metal fiber material in a continuous manner, ‘atmospheric’ plasma which does not require vacuum must be utilized. Plasma is created by applying voltage across two electrodes, which in turn ionizes the gaseous species between the two electrodes. A plasma environment can be applied to a metal fiber substrate in a ‘downstream’ manner in which the ionized gases are flowed down toward the substrate. It is also possible to send the metal fiber substrate between the two electrodes and into the plasma environment to be treated.

In some embodiments, the metal fiber can be treated with a plasma environment prior to barrier coating application. For example, a plasma treated metal fiber material can have a higher surface energy and therefore allow for better wet-out and coverage of the barrier coating. The plasma process can also add roughness to the metal fiber surface allowing for better mechanical bonding of the barrier coating in the same manner as mentioned above.

The catalyst can be prepared as a liquid solution that contains CNT-forming catalyst that includes transition metal nanoparticles. The diameters of the synthesized nanotubes are related to the size of the metal particles as described above. In some embodiments, commercial dispersions of CNT-forming transition metal nanoparticle catalyst are available and are used without dilution, in other embodiments commercial dispersions of catalyst can be diluted. Whether or not to dilute such solutions can depend on the desired density and length of CNT to be grown as described above.

Carbon nanotube synthesis can be based on a chemical vapor deposition (CVD) process and occurs at elevated temperatures. The specific temperature is a function of catalyst choice, but will typically be in a range of about 500 to 1000° C. Accordingly, this involves heating the barrier-coated metal fiber material to a temperature in the aforementioned range to support carbon nanotube synthesis. When using metal fiber materials having lower melting points, or that are temperature sensitive, a pre-heat of the feedstock and carrier gas can be employed as describer further below.

CVD-promoted nanotube growth on the catalyst-laden metal fiber material is then performed. The CVD process can be promoted by, for example, a carbon-containing feedstock gas such as acetylene, ethylene, and/or ethanol. The CNT synthesis processes generally use an inert gas (nitrogen, argon, helium) as a primary carrier gas. The carbon feedstock is provided in a range from between about 0% to about 15% of the total mixture. A substantially inert environment for CVD growth is prepared by removal of moisture and oxygen from the growth chamber.

In the CNT synthesis process, CNTs grow at the sites of a CNT-forming transition metal nanoparticle catalyst. The presence of a strong plasma-creating electric field can be optionally employed to affect nanotube growth. That is, the growth tends to follow the direction of the electric field. By properly adjusting the geometry of the plasma spray and electric field, vertically-aligned CNTs (i.e., perpendicular to the metal fiber material) can be synthesized. Under certain conditions, even in the absence of a plasma, closely-spaced nanotubes will maintain a vertical growth direction resulting in a dense array of CNTs resembling a carpet or forest. The presence of the barrier coating can also influence the directionality of CNT growth.

The operation of disposing a catalyst on the metal fiber material can be accomplished by spraying or dip coating a solution or by gas phase deposition via, for example, a plasma process. The choice of techniques can be coordinated with the mode with which the barrier coating is applied. Thus, in some embodiments, after forming a solution of a catalyst in a solvent, catalyst can be applied by spraying or dip coating the barrier coated metal fiber material with the solution, or combinations of spraying and dip coating. Either technique, used alone or in combination, can be employed once, twice, thrice, four times, up to any number of times to provide a metal fiber material that is sufficiently uniformly coated with CNT-forming catalyst. When dip coating is employed, for example, a metal fiber material can be placed in a first dip bath for a first residence time in the first dip bath. When employing a second dip bath, the metal fiber material can be placed in the second dip bath for a second residence time. For example, metal fiber materials can be subjected to a solution of CNT-forming catalyst for between about 3 seconds to about 90 seconds depending on the dip configuration and linespeed. Employing spraying or dip coating processes, a metal fiber material with a surface density of catalyst of less than about 5% surface coverage to as high as about 80% coverage, in which the CNT-forming catalyst nanoparticles are nearly a monolayer. In some embodiments, the process of coating the CNT-forming catalyst on the metal fiber material should produce no more than a monolayer. For example, CNT growth on a stack of CNT-forming catalyst can erode the degree of infusion of the CNT to the metal fiber material. In other embodiments, the transition metal catalyst can be deposited on the metal fiber material using evaporation techniques, electrolytic deposition techniques, and other processes known to those skilled in the art, such as addition of the transition metal catalyst to a plasma feedstock gas as a metal organic, metal salt or other composition promoting gas phase transport.

Because processes of the invention are designed to be continuous, a spoolable metal fiber material can be dip-coated in a series of baths where dip coating baths are spatially separated. In a continuous process in which nascent metal fibers are being generated de novo, dip bath or spraying of CNT-forming catalyst can be the first step after applying and curing or partially curing a barrier coating to the metal fiber material. In other embodiments, the CNT-forming catalyst can be applied to newly formed metal fibers in the presence of other sizing agents after barrier coating. Such simultaneous application of CNT-forming catalyst and other sizing agents can still provide the CNT-forming catalyst in surface contact with the barrier coating of the metal fiber material to insure CNT infusion.

The catalyst solution employed can be a transition metal nanoparticle which can be any d-block transition metal as described above. In addition, the nanoparticles can include alloys and non-alloy mixtures of d-block metals in elemental form or in salt form, and mixtures thereof. Such salt forms include, without limitation, oxides, carbides, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the metal fiber by applying or infusing a CNT-forming catalyst directly to the metal fiber material simultaneously with barrier coating deposition. Many of these transition metal catalysts are readily commercially available from a variety of suppliers, including, for example, Ferrotec Corporation (Bedford, N.H.).

Catalyst solutions used for applying the CNT-forming catalyst to the metal fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent. Such concentrations can be used when the barrier coating and CNT-forming catalyst is applied simultaneously as well. In some embodiments heating of the barrier coated metal fiber material can be at a temperature that is between about 500° C. and 1000° C. depending on the specific metal substrate to synthesize carbon nanotubes after deposition of the CNT-forming catalyst. Heating at these temperatures can be performed prior to or substantially simultaneously with introduction of a carbon feedstock for CNT growth, although specific and separate heating conditions for the carbon feedstock and metal fiber material can be controlled, as explained further below. Furthermore, the actual temperature to be employed will also be a function of the metal fiber material's temperature tolerance, which can be mitigated by the presence of the barrier coating.

In some embodiments, the present invention provides a process that includes removing sizing agents from a metal fiber material, applying a barrier coating conformally over the metal fiber material, applying a CNT-forming catalyst to the metal fiber material, heating the metal fiber material to at least 500° C., and synthesizing carbon nanotubes on the metal fiber material. In some embodiments, operations of the CNT-infusion process include removing sizing from a metal fiber material, applying a barrier coating to the metal fiber material, applying a CNT-forming catalyst to the metal fiber, heating the fiber to CNT-synthesis temperature and CVD-promoted CNT growth the catalyst-laden metal fiber material. Thus, where commercial metal fiber materials are employed, processes for constructing CNT-infused metal fibers can include a discrete step of removing sizing from the metal fiber material before disposing barrier coating and the catalyst on the metal fiber material.

The step of synthesizing carbon nanotubes can include numerous techniques for forming carbon nanotubes, including those disclosed in co-pending U.S. Patent Application No. US 2004/0245088 which is incorporated herein by reference. The CNTs grown on fibers of the present invention can be accomplished by techniques known in the art including, without limitation, micro-cavity, thermal or plasma-enhanced CVD techniques, laser ablation, arc discharge, and high pressure carbon monoxide (HiPCO). During CVD, in particular, a barrier coated metal fiber material with CNT-forming catalyst disposed thereon, can be used directly. In some embodiments, any conventional sizing agents can be optionally removed prior to CNT synthesis. In some embodiments, acetylene gas is ionized to create a jet of cold carbon plasma for CNT synthesis. The plasma is directed toward the catalyst-bearing metal fiber material. Thus, in some embodiments synthesizing CNTs on a metal fiber material includes (a) forming a carbon plasma; and (b) directing the carbon plasma onto said catalyst disposed on the metal fiber material. The diameters of the CNTs that are grown are dictated, in part, by the size of the CNT-forming catalyst as described above. To initiate the growth of CNTs, two gases are bled into the reactor: a carrier or process gas such as argon, helium, or nitrogen, and a carbon-containing feedstock gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor vertically aligned carbon nanotubes can be grown radially about a cylindrical fiber. In some embodiments, a plasma is not required for radial growth about the fiber. For metal fiber materials that have distinct sides such as tapes, mats, fabrics, plies, ribbons, meshes, and solid and perforated sheets, catalyst can be disposed on one or both sides and correspondingly, CNTs can be grown on one or both sides as well.

As described above, CNT-synthesis is performed at a rate sufficient to provide a continuous process for functionalizing spoolable metal fiber materials. Numerous apparatus configurations facilitate such continuous synthesis as exemplified below.

In some embodiments, CNT-infused metal fiber materials can be constructed in an “all plasma” process. In such embodiments, barrier coated metal fiber materials pass through numerous plasma-mediated steps to form the final CNT-infused product. The first of the plasma processes, can include a step of fiber surface modification. This is a plasma process for “roughing” the surface of the barrier coating on the metal fiber material to facilitate catalyst deposition, as described above. As described above, surface modification can be achieved using a plasma of any one or more of a variety of different gases, including, without limitation, argon, helium, oxygen, ammonia, hydrogen, and nitrogen.

After surface modification, the barrier coated metal fiber material proceeds to catalyst application. This is a plasma process for depositing the CNT-forming catalyst on the fibers. The CNT-forming catalyst is typically a transition metal as described above. The transition metal catalyst can be added to a plasma feedstock gas as a precursor in the form of a ferrofluid, a metal organic, metal salt or other composition for promoting gas phase transport. The catalyst can be applied at room temperature in the ambient environment with neither vacuum nor an inert atmosphere being required. In some embodiments, the metal fiber material is cooled prior to catalyst application.

Continuing the all-plasma process, carbon nanotube synthesis occurs in a CNT-growth reactor. This can be achieved through the use of plasma-enhanced chemical vapor deposition, wherein carbon plasma is sprayed onto the catalyst-laden fibers. Since carbon nanotube growth occurs at elevated temperatures (typically in a range of about 500 to 1000° C. depending on the metal substrate and catalyst), the catalyst-laden fibers can be heated prior to exposing to the carbon plasma. After heating, the metal fiber material is ready to receive the carbon plasma. The carbon plasma is generated, for example, by passing a carbon containing gas such as acetylene, ethylene, ethanol, and the like, through an electric field that is capable of ionizing the gas. This cold carbon plasma is directed, via spray nozzles, to the metal fiber material. The metal fiber material can be in close proximity to the spray nozzles, such as within about 1 centimeter of the spray nozzles, to receive the plasma. In some embodiments, heaters are disposed above the metal fiber material at the plasma sprayers to maintain the elevated temperature of the metal fiber material.

A further design configuration for continuous carbon nanotube synthesis involves a special rectangular reactor for the synthesis and growth of carbon nanotubes directly on metal fiber materials. The reactor can be designed for use in a continuous in-line process for producing carbon-nanotube bearing metal fiber materials. In some embodiments, CNTs are grown via a chemical vapor deposition (“CVD”) process at atmospheric pressure and at elevated temperature in the range of about 550° C. to about 800° C. in a multi-zone reactor depending on the specific metal substrate. The fact that the synthesis occurs at atmospheric pressure is one factor that facilitates the incorporation of the reactor into a continuous processing line for CNT-on-fiber synthesis. Another advantage consistent with in-line continuous processing using such a zone reactor is that CNT growth occurs in seconds, as opposed to minutes (or longer) as in other procedures and apparatus configurations typical in the art.

CNT synthesis reactors in accordance with the various embodiments include the following features: Rectangular Configured Synthesis Reactors: The cross section of a typical CNT synthesis reactor known in the art is circular. There are a number of reasons for this including, for example, historical reasons (cylindrical reactors are often used in laboratories) and convenience (flow dynamics are easy to model in cylindrical reactors, heater systems readily accept circular tubes (quartz, etc.), and ease of manufacturing. Departing from the cylindrical convention, the present invention provides a CNT synthesis reactor having a rectangular cross section. The reasons for the departure are as follows:

1. Since many metal fiber materials that can be processed by the reactor are relatively planar such as flat tape or sheet-like in form, a circular cross section is an inefficient use of the reactor volume. This inefficiency results in several drawbacks for cylindrical CNT synthesis reactors including, for example, a) maintaining a sufficient system purge; increased reactor volume requires increased gas flow rates to maintain the same level of gas purge. This results in a system that is inefficient for high volume production of CNTs in an open environment; b) increased carbon feedstock gas flow; the relative increase in inert gas flow, as per a) above, requires increased carbon feedstock gas flows. Consider that the volume of a 12K metal fiber tow is 2000 times less than the total volume of a synthesis reactor having a rectangular cross section. In an equivalent growth cylindrical reactor (i.e., a cylindrical reactor that has a width that accommodates the same planarized metal fiber material as the rectangular cross-section reactor), the volume of the metal fiber material is 17,500 times less than the volume of the chamber. Although gas deposition processes, such as CVD, are typically governed by pressure and temperature alone, volume has a significant impact on the efficiency of deposition. With a rectangular reactor there is a still excess volume. This excess volume facilitates unwanted reactions; yet a cylindrical reactor has about eight times that volume. Due to this greater opportunity for competing reactions to occur, the desired reactions effectively occur more slowly in a cylindrical reactor chamber. Such a slow down in CNT growth, is problematic for the development of a continuous process. One benefit of a rectangular reactor configuration is that the reactor volume can be decreased by using a small height for the rectangular chamber to make this volume ratio better and reactions more efficient. In some embodiments of the present invention, the total volume of a rectangular synthesis reactor is no more than about 3000 times greater than the total volume of a metal fiber material being passed through the synthesis reactor. In some further embodiments, the total volume of the rectangular synthesis reactor is no more than about 4000 times greater than the total volume of the metal fiber material being passed through the synthesis reactor. In some still further embodiments, the total volume of the rectangular synthesis reactor is less than about 10,000 times greater than the total volume of the metal fiber material being passed through the synthesis reactor. Additionally, it is notable that when using a cylindrical reactor, more carbon feedstock gas is required to provide the same flow percent as compared to reactors having a rectangular cross section. It should be appreciated that in some other embodiments, the synthesis reactor has a cross section that is described by polygonal forms that are not rectangular, but are relatively similar thereto and provide a similar reduction in reactor volume relative to a reactor having a circular cross section; c) problematic temperature distribution; when a relatively small-diameter reactor is used, the temperature gradient from the center of the chamber to the walls thereof is minimal. But with increased size, such as would be used for commercial-scale production, the temperature gradient increases. Such temperature gradients result in product quality variations across a metal fiber material (i.e., product quality varies as a function of radial position). This problem is substantially avoided when using a reactor having a rectangular cross section. In particular, when a planar substrate is used, reactor height can be maintained constant as the size of the substrate scales upward. Temperature gradients between the top and bottom of the reactor are essentially negligible as well and, as a consequence, thermal issues and the product-quality variations that can result are avoided.

2. Gas introduction: Because tubular furnaces are normally employed in the art, typical CNT synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the rectangular CNT reactors.

Zoning. Chambers that provide a relatively cool purge zone depend from both ends of the rectangular synthesis reactor used in the continuous process. Applicants have determined that if hot gas were to mix with the external environment (i.e., outside of the reactor), there would be an increase in degradation of the metal fiber material. The cool purge zones provide a buffer between the internal system and external environments. Typical CNT synthesis reactor configurations known in the art typically require that the substrate is carefully (and slowly) cooled. The cool purge zone at the exit of the present rectangular CNT growth reactor achieves the cooling in a short period of time, as required for the continuous in-line processing.

Non-contact, hot-walled, metallic reactor. In some embodiments, a hot-walled reactor made of metal is employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation. However, Applicants have observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produce a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot creates blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and CNT Synthesis. In the CNT synthesis reactor disclosed herein, both catalyst reduction and CNT growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present invention due, at least in part, to the fact that carbon feedstock gas is introduced at the center of the reactor, not the end as would be typical in the art using cylindrical reactors. The reduction process occurs as the fibers enter the heated zone; by this point, the gas has had time to react with the walls and cool off prior to reacting with the catalyst and causing the oxidation-reduction (via hydrogen radical interactions). It is this transition region where the reduction occurs. At the hottest isothermal zone in the system, the CNT growth occurs, with the greatest growth rate occurring proximal to the gas inlets near the center of the reactor.

A low temperature system can be employed especially in the case of low melting, or especially temperature sensitive, metal fiber materials. Such a system includes a growth chamber, a heater, a metal fiber material source, a carbon feed gas source, a process or carrier gas source, a gas pre-heater, and a controller.

In some embodiments, growth chamber is an open-air continuous operation, flow through reactor. The system can operate at atmospheric pressure, in some embodiments, and at reduced pressures in other embodiments. The growth chamber includes a small volume cavity (not shown) through which a metal fiber material enters from one end and exits from a second end continuously, thereby facilitating continuous synthesis of carbon nanotubes on the metal fiber material. A metal fiber material, such as a tow, for example, allows for a continuous feed of metal fiber from upstream source.

A gas mixture containing a carbon feedstock gas and a process or carrier gas can be continuously fed into the chamber cavity. The growth chamber can be formed by two vertical members and two horizontal members, arranged in a generally H-shaped configuration. The growth chamber has a small cavity volume, as described above to enhance the CNT growth rate. A metal fiber material with appropriate barrier coating and CNT-forming catalyst passes through the growth chamber at one end at a rate determined by a controller at a first temperature T1 maintained by the same controller, or optionally, a separate controller operably-linked to the first controller. Temperature T1 is sufficiently high to allow the growth of carbon nanotubes on the metal fiber material, but not so high as to adversely impact the physical and chemical properties of the metal fiber material. The integrity of the fiber can also be protected by the presence of the barrier coating, which can act as a thermal insulator. For example, first temperature T1 can be about 350-650° C. Pre-heated carbon feedstock and any carrier gas is provided at temperature T2, a temperature higher than T1, to facilitate CNT synthesis on the metal fiber material. After CNT synthesis the metal fiber material exits the growth chamber at the opposite end. From there the CNT-infused metal fiber material can be subjected to numerous post CNT growth processing steps such as application of sizing agents.

A heater heats the cavity of the growth chamber and maintains the operational temperature T1 of the chamber at a pre-set level. In some embodiments, the heater, controlled by the controller, takes the form of a heating coil contained in each of the horizontal members. Because the horizontal members are closely spaced to provide a small volume cavity, the gap through which the metal fiber material passes is uniformly heated without any significant temperature gradient. Thus, the heater heats the surfaces of the horizontal members to provide uniform heating throughout the growth chamber. In some embodiments, the gap between the horizontal members is about 1 to about 25 mm.

The metal fiber material source can be adapted to continuously supply the metal fiber material to the growth chamber. A typical metal fiber material can be supplied as a tow, yarn, fabric, or other form as disclosed herein above. A carbon feed gas source is in fluid communication with a gas pre-heater. The gas pre-heater is thermally isolated from the growth chamber to prevent unintentional heating of the growth chamber. Furthermore, the gas pre-heater is thermally insulated from the environment. The gas per-heater can include resistive heat torches, coiled tubes heated inside a resistively heated ceramic heater, induction heating, hot filaments in the gas stream, and infrared heating. In some embodiments, carbon feed gas source and a process gas are mixed before the being supplied to the pre-heater. The carbon feed gas source is heated by the pre-heater to temperature T2, such that the carbon feed is dissociated or thermally “cracked” into the requisite free carbon radicals which, in the presence of the CNT-forming catalyst disposed on the metal fiber material, facilitate CNT growth. In some embodiments, the carbon feed gas source is acetylene and the process gas is nitrogen, helium, argon, or mixtures thereof. Acetylene gas as the carbon feed source obviates the need for a separate process of introducing hydrogen into the growth chamber to reduce transition metal nanoparticle catalysts that are in their oxide form. The flow rates of the carbon feed gas source and process gas can also be maintained by the controller, or optionally, by another controller operably-linked to first controller.

It is understood that the controller can be adapted to independently sense, monitor, and control the system parameters as detailed above. The controller (multiple controllers) can be an integrated, automated computerized system controller that receives parameter data and performs various automated adjustments of control parameters or a manual control arrangement.

In some embodiments, when a carbon feed gas containing acetylene is heated to a temperature T2, which can be between, for example, 550-1000° C., and fed into the growth chamber, the acetylene dissociates into carbon and hydrogen in the presence of the catalyst on the metal fiber material. The higher temperature T2 facilitates rapid dissociation of acetylene, but because it is heated externally in the pre-heater, while maintaining chamber temperature at lower temperature T1, the integrity of the metal fiber material is preserved during CNT synthesis.

Alternatively, a diffuser is disposed between the pre-heater and the growth chamber. The diffuser provides a uniform distribution of the carbon feed gas and process gas mixture over the metal fiber material in the growth chamber. In some embodiments, the diffuser takes the form of a plate with uniformly distributed apertures for gas delivery. In some embodiments, the diffuser extends along a selected section of the growth chamber. In alternate embodiments, the diffuser extends along the entirety of the growth chamber. The diffuser can be positioned adjacent to the growth chamber in a horizontal direction along vertical members. In still other embodiments, the diffuser is positioned adjacent to the growth chamber in a vertical direction along the members. In yet another embodiment, the diffuser is incorporated into the pre-heater.

In some embodiments, when loosely affiliated metal fiber materials, such as a tow are employed, the continuous process can include steps that spread out the strands and/or filaments of the tow. Thus, as a tow is unspooled it can be spread using a vacuum-based fiber spreading system, for example. When employing sized metal fiber materials, which can be relatively stiff, additional heating can be employed in order to “soften” the tow to facilitate fiber spreading. The spread fibers which comprise individual filaments can be spread apart sufficiently to expose an entire surface area of the filaments, thus allowing the tow to more efficiently react in subsequent process steps. For example, the spread metal fiber tow can pass through a surface treatment step that is composed of a plasma system and/or barrier coating as described above. The roughened and/or coated, spread fibers then can pass through a CNT-forming catalyst dip bath. The result is fibers of the metal fiber tow that have catalyst particles distributed radially on their surface. The catalyst-laden fibers of the tow then enter an appropriate CNT growth chamber, such as the rectangular chamber equipped with a gas pre-heater as described above, where a flow through atmospheric pressure CVD or PE-CVD process is used to synthesize the CNTs at rates as high as several microns per second, including between about 0.1 to 10 microns per second. The fibers of the tow, now with radially aligned CNTs, exit the CNT growth reactor.

In some embodiments, CNT-infused metal fiber materials can pass through yet another treatment process that, in some embodiments is a plasma process used to functionalize the CNTs. Additional functionalization of CNTs can be used to promote their adhesion to particular resins. Thus, in some embodiments, the present invention provides CNT-infused metal fiber materials having functionalized CNTs.

As part of the continuous processing of spoolable metal fiber materials, the a CNT-infused metal fiber material can further pass through a sizing dip bath to apply any additional sizing agents which can be beneficial in a final product. Finally if wet winding is desired, the CNT-infused metal fiber materials can be passed through a resin bath and wound on a mandrel or spool. The resulting metal fiber material/resin combination locks the CNTs on the metal fiber material allowing for easier handling and composite fabrication. In some embodiments, CNT infusion is used to provide improved filament winding. Thus, CNTs formed on metal fibers such as metal tow, are passed through a resin bath to produce resin-impregnated, CNT-infused metal tow. After resin impregnation, the metal tow can be positioned on the surface of a rotating mandrel by a delivery head. The tow can then be wound onto the mandrel in a precise geometric pattern in known fashion.

The winding process described above provides pipes, tubes, or other forms as are characteristically produced via a male mold. But the forms made from the winding process disclosed herein differ from those produced via conventional filament winding processes. Specifically, in the process disclosed herein, the forms are made from composite materials that include CNT-infused tow. Such forms will therefore benefit from enhanced strength and the like, as provided by the CNT-infused tow.

In some embodiments, a continuous process for infusion of CNTs on spoolable metal fiber materials can achieve a linespeed between about 0.5 ft/min to about 36 ft/min. In this embodiment where the system is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length.

In some embodiments, more than one metal fiber material can be run simultaneously through the process. For example, multiple tapes tows, filaments, strand and the like can be run through the process in parallel. Thus, any number of pre-fabricated spools of metal fiber material can be run in parallel through the process and re-spooled at the end of the process. The number of spooled metal fiber materials that can be run in parallel can include one, two, three, four, five, six, up to any number that can be accommodated by the width of the CNT-growth reaction chamber. Moreover, when multiple metal fiber materials are run through the process, the number of collection spools can be less than the number of spools at the start of the process. In such embodiments, metal yarn, tows, or the like can be sent through a further process of combining such metal fiber materials into higher ordered metal fiber materials such as woven fabrics or the like. The continuous process can also incorporate a post processing chopper that facilitates the formation CNT-infused metal chopped fiber mats, for example.

In some embodiments, processes of the invention allow for synthesizing a first amount of a first type of carbon nanotube on the metal fiber material, in which the first type of carbon nanotube is selected to alter at least one first property of the metal fiber material. Subsequently, processes of the invention allow for synthesizing a second amount of a second type of carbon nanotube on the metal fiber material, in which the second type of carbon nanotube is selected to alter at least one second property of the metal fiber material.

In some embodiments, the first amount and second amount of CNTs are different. This can be accompanied by a change in the CNT type or not. Thus, varying the density of CNTs can be used to alter the properties of the original metal fiber material, even if the CNT type remains unchanged. CNT type can include CNT length and the number of walls, for example. In some embodiments the first amount and the second amount are the same. If different properties are desirable in this case, along the two different stretches of the spoolable material, then the CNT type can be changed, such as the CNT length. For example, longer CNTs can be useful in electrical/thermal applications, while shorter CNTs can be useful in mechanical strengthening applications.

In light of the aforementioned discussion regarding altering the properties of the metal fiber materials, the first type of carbon nanotube and the second type of carbon nanotube can be the same, in some embodiments, while the first type of carbon nanotube and the second type of carbon nanotube can be different, in other embodiments. Likewise, the first property and the second property can be the same, in some embodiments. For example, the EMI shielding property can be the property of interest addressed by the first amount and type of CNTs and the 2nd amount and type of CNTs, but the degree of change in this property can be different, as reflected by differing amounts, and/or types of CNTs employed. Finally, in some embodiments, the first property and the second property can be different. Again this may reflect a change in CNT type. For example the first property can be mechanical strength with shorter CNTs, while the second property can be electrical/thermal properties with longer CNTs. One skilled in the art will recognize the ability to tailor the properties of the metal fiber material through the use of different CNT densities, CNT lengths, and the number of walls in the CNTs, such as single-walled, double-walled, and multi-walled, for example.

In some embodiments, processes of the present invention provides synthesizing a first amount of carbon nanotubes on a metal fiber material, such that this first amount allows the carbon nanotube-infused metal fiber material to exhibit a second group of properties that differ from a first group of properties exhibited by the metal fiber material itself. That is, selecting an amount that can alter one or more properties of the metal fiber material, such as tensile strength. The first group of properties and second group of properties can include at least one of the same properties, thus representing enhancing an already existing property of the metal fiber material. In some embodiments, CNT infusion can impart a second group of properties to the carbon nanotube-infused metal fiber material that is not included among the first group of properties exhibited by said metal fiber material itself.

In some embodiments, a first amount of carbon nanotubes is selected such that the value of at least one property selected from the group consisting of tensile strength, Young's Modulus, shear strength, shear modulus, toughness, compression strength, compression modulus, density, EM wave absorptivity/reflectivity, acoustic transmittance, electrical conductivity, and thermal conductivity of the carbon nanotube-infused metal fiber material differs from the value of the same property of the metal fiber material itself.

Tensile strength can include three different measurements: 1) Yield strength which evaluates the stress at which material strain changes from elastic deformation to plastic deformation, causing the material to deform permanently; 2) Ultimate strength which evaluates the maximum stress a material can withstand when subjected to tension, compression or shearing; and 3) Breaking strength which evaluates the stress coordinate on a stress-strain curve at the point of rupture. Multiwalled carbon nanotubes, in particular, have the highest tensile strength of any material yet measured, with a tensile strength of 63 GPa having been achieved. Moreover, theoretical calculations have indicated possible tensile strengths of CNTs of about 300 GPa. Thus, CNT-infused metal fiber materials, are expected to have substantially higher ultimate strength compared to the parent metal fiber material. As described above, the increase in tensile strength will depend on the exact nature of the CNTs used as well as the density and distribution on the metal fiber material. CNT-infused metal fiber materials can exhibit a 1.5 times improvement in tensile properties, for example. Exemplary CNT-infused metal fiber materials can have as high as two times the shear strength as the parent unfunctionalized metal fiber material and as high as two times the compression strength.

Young's modulus is a measure of the stiffness of an isotropic elastic material. It is defined as the ratio of the uniaxial stress over the uniaxial strain in the range of stress in which Hooke's Law holds. This can be experimentally determined from the slope of a stress-strain curve created during tensile tests conducted on a sample of the material.

Composite shear strength evaluates the stress at which a material fails when a load is applied perpendicular to the fiber direction. Compression strength evaluates the stress at which a material fails when a compressive load is applied.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet.

The CNT-infused metal fiber materials can benefit from the presence of CNTs not only in the properties described above, but can also provide lighter materials in the process. Thus, such lower density and higher strength materials translates to greater strength to weight ratio.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other processes, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A system comprising:
a reusable substrate upon which a carbon nanostructure is formed in the system to provide a carbon nanostructure laden reusable substrate;
a first conveyor system adapted to continuously convey the reusuable substrate through a carbon nanotube catalyst application station and carbon nanostructure growth station; and
a second conveyor system adapted to create an interface between a second substrate and the carbon nanostructure-laden reusuable substrate, the interface facilitating transfer of a carbon nanostructure from the carbon nanostructure-laden reusuable substrate to the second substrate.

2. The system of claim 1, wherein the reusable substrate comprises a fiber material or a sheet.

3. The system of claim 1, wherein the carbon nanostructure growth station comprises a microcavity.

4. The system of claim 1, wherein the carbon nanostructure growth station allows synthesis of the carbon nanostructure on the reusable substrate at a growth rate of several microns per second.

5. The system of claim 1, wherein the second substrate is a pre-preg.

6. The system of claim 1, further comprising an anti-adhesive coating station.

7. The system of claim 1, further comprising a carbon nanostructure modification station.

8. A method comprising:
growing a carbon nanostructure on a reusable substrate, the carbon nanostructure comprising a carbon nanotube polymer having a structural morphology comprising interdigitation, branching, crosslinking, and shared walls; and
transferring the carbon nanostructure to a second substrate to provide a carbon nanostructure-laden second substrate,
wherein the method is adapted for continuous carbon nanostructure production on the reusable substrate.

9. The method of claim 8, wherein the reusable substrate is a fiber material or a sheet.

10. The method of claim 8, further comprising applying an carbon nanotube growth catalyst to the reusable substrate.

11. The method of claim 10, further comprising applying an anti-adhesive coating to the reusable substrate.

12. The method of claim 8, wherein the second substrate is a pre-preg or resin film.

13. The method of claim 8, further comprising transferring the carbon nanostructure from the second substrate to a third substrate.

14. The method of claim 8, further comprising chopping the second substrate after transferring the carbon nanostructure to the second substrate.

15. The method of claim 8, further comprising disposing the carbon nanostructure laden second substrate in a matrix material to provide a composite.

16. A pre-preg comprising a carbon nanostructure, the carbon nanostructure comprising a carbon nanotube polymer having a structural morphology comprising interdigitation, branching, crosslinking, and shared walls.
